(19) United States
(12) Patent Application Publication
(10) Pub. No.: US 2026/0070008 A1
(43) Pub. Date: Mar. 12, 2026

(54) In-line Fluid Filtering Surface Unit

(71) Applicant: Major Manufacturing & Supply, LLC, Broussard, LA (US)

(72) Inventors: Cambre Allen Romero, Broussard, LA (US); Clayton Allen Romero, Broussard, LA (US)

(73) Assignee: Major Manufacturing & Supply, LLC, Broussard, LA (US)

(21) Appl. No.: 19/321,702

(22) Filed: Sep. 8, 2025

Related U.S. Application Data
(60) Provisional application No. 63/691,831, filed on Sep. 6, 2024.
(60) Provisional application No. 63/818,501, filed on Jun. 5, 2025.

(51) Int. Cl. B01D 35/06; B01D 29/11; B01D 29/90; B01D 29/92; B01D 29/96

(52) U.S. Cl. CPC B01D 35/06; B01D 29/11; B01D 29/902; B01D 29/925; B01D 29/96; B01D 2201/4092

(57) ABSTRACT

A system and method for in-line filtering of fluids used in oil and gas production operations is provided, comprising a filter cartridge comprising a filter contained within a filter conduit; a first valve in fluid communication with a first end of the filter cartridge; a second valve in fluid communication with a second end of the filter cartridge; and a threadable ram conduit in fluid communication between the first valve and the filter cartridge, wherein the threadable ram conduit is movable between a first position to sealingly engage the filter cartridge and a second position to disengage the filter cartridge.

### CROSS-REFERENCE TO RELATED APPLICATIONS

None.

### BACKGROUND OF THE INVENTION

### 1. Field of the Invention

The present invention relates to devices and methods used for the filtration or diffusing of debris and loss circulation material from drilling and completion fluids used in oil and gas production operations, including collection of magnetic debris, and more particularly to such devices and methods which enable the in-line change of filtration elements using a telescoping ram conduit.

### 2. Prior Art

Drilling fluids, also known as drilling muds, play a crucial role in the drilling process in oil and gas production. These fluids are used to lubricate the drill bit, stabilize the wellbore, control pressure, and carry drill cuttings to the surface. Completion fluids, also known as workover fluids or well completion fluids, are specialized fluids used during the completion phase of an oil or gas well. The completion phase involves preparing the well for production after it has been drilled. This includes operations such as installing the production tubing, setting packers, perforating the casing, and other activities necessary to enable the well to produce hydrocarbons efficiently and safely. Filtering the drilling and completion fluids is essential to maintain their effectiveness and prevent damage to the drilling equipment and other downhole structures.

While there are a number of techniques used to filter such fluids, it is most common to use filters and screens to ensure that the fluid remains clean and effective throughout the drilling or completion process. Proper filtration of fluids helps in maintaining the efficiency of the drilling operation, controlling well pressure, protecting the formation, protecting the equipment, and ensuring the safety of the drilling site.

Periodically, the filters must be removed, cleaned, and replaced so that efficient filtering is accomplished. Several companies currently provide such filtering systems and employ various means to replace filters as they become dirty or clogged with debris. However, none of the current filtering systems employ an in-line telescoping conduit which operates to engage or disengage a filter or diffuser cartridge along the axis of the fluid flow direction so that the cartridge can be replaced. For the purposes of this invention, and as noted in the detailed description below, the word “filter” or “filtration” is used to mean either a filter, screen, diffuser, or a combination of those devices having equivalent functions.

Therefore, there is a need for an improved surface unit for in-line filtration of drilling and completion fluids that: (1) enables quicker and more efficient change-out of filtration components, and (2) provides for stand-by filtration components on the surface unit.

### SUMMARY OF THE INVENTION

A system for in-line filtering of fluids used in oil and gas production operations is provided, comprising a filter cartridge comprising a filter contained within a filter conduit; a first valve in fluid communication with a first end of the filter cartridge; a second valve in fluid communication with a second end of the filter cartridge; and a threaded telescoping ram conduit in fluid communication between the first valve and the filter cartridge, wherein the threaded telescoping ram conduit is movable between a first position to sealingly engage the filter cartridge and a second position to disengage the filter cartridge.

The filter residing within the filter conduit may be a filter, a diffuser, or a screen, and may further include magnets to collect ferrous metals from the fluid.

For portability advantages in a preferred embodiment, the first valve and the second valve, as well as other components within the system, are attached to a skid. The skid preferably includes a trough having a discharge port to allow fluids from replaced filter cartridges to drain.

The system further includes a table frame positioned below the filter cartridge, wherein the table frame includes a first retaining member adapted to retain a replacement filter cartridge. The table frame may further include a second retaining member adapted to retain a filter cartridge that has been disengaged from the ram conduit.

In a preferred embodiment, the ram conduit is sealingly, telescopingly, and threadably disposed within a ram sleeve mounted to a fixed location such as the skid, and the ram sleeve is mounted within a mounting member.

A method of in-line filtering of fluids is also provided, comprising the steps of providing a filter cartridge having a filter contained within a filter conduit, wherein the filter cartridge has a first end and a second end, wherein the first end of the filter cartridge is in fluid communication with a first valve, and wherein the second end of the filter cartridge is in fluid communication with a second valve; providing a threaded telescoping ram conduit in fluid communication between the first valve and filter cartridge; positioning the ram conduit to sealingly engage the filter cartridge; and opening the first valve and the second valve to allow the fluid to flow through the filter cartridge.

The method further comprising the steps of, after a predetermined period, closing the first valve and the second valve; positioning the ram conduit to disengage the filter cartridge; positioning a replacement filter cartridge between the first valve and the second valve; and positioning the ram conduit to sealingly engage the replacement filter cartridge. In a preferred embodiment, positioning the ram conduit to sealingly engage the filter cartridge is achieved using a threaded connection, although any other powered or manual mechanical means of positioning the ram conduit would be effective, as long as a suitable sealing engagement of the ram conduit with the filter cartridge is achieved based on fluid pressure within the system during operation.

As with the system itself, the filter used in the method may be a filter, a diffuser, or a screen, and may further include magnets to collect ferrous metals from the fluid.

### BRIEF DESCRIPTION OF THE DRAWINGS

For a further understanding of the nature, objects, and advantages of the present invention, reference should be had to the following detailed description, read in conjunction with the following drawings, wherein like reference numerals denote like elements.

FIG. 1 shows a perspective view of a preferred embodiment of a surface unit for filtration of drilling and completion fluids in oil and gas production operations in accordance with the present invention.

FIG. 2 shows another perspective view of the embodiment of FIG. 1.

FIG. 3 shows an alternative embodiment of the invention without the skid and trough which can be positioned at a site.

FIG. 4 shows a detailed view of the table frame.

FIG. 5 shows another detailed view of the table frame.

FIG. 6 shows a sectional view of the ram cylinder, filter, filter cartridge, and hammer unions when the filter cartridge is in an operational position.

### DETAILED DESCRIPTION OF THE INVENTION

Before the subject invention is further described, it is to be understood that the invention is not limited to the particular embodiments of the invention described below, as variations of the particular embodiments may be made and still fall within the scope of the appended claims. It is also to be understood that the terminology employed is for the purpose of describing particular embodiments and is not intended to be limiting. Instead, the scope of the present invention will be established by the appended claims.

In this specification and the appended claims, the singular forms “a,” “an,” and “the” include plural reference unless the context clearly dictates otherwise. Unless defined otherwise, all technical and scientific terms used herein have the same meaning as commonly understood to one of ordinary skill in the art to which this invention belongs.

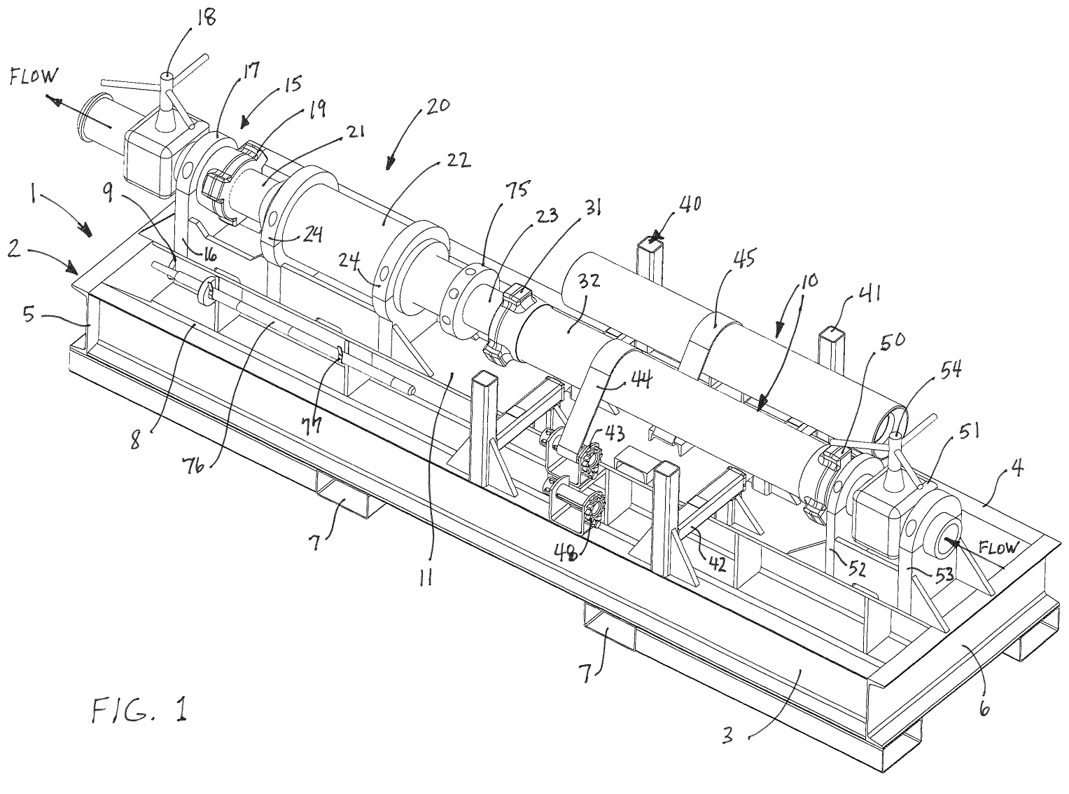

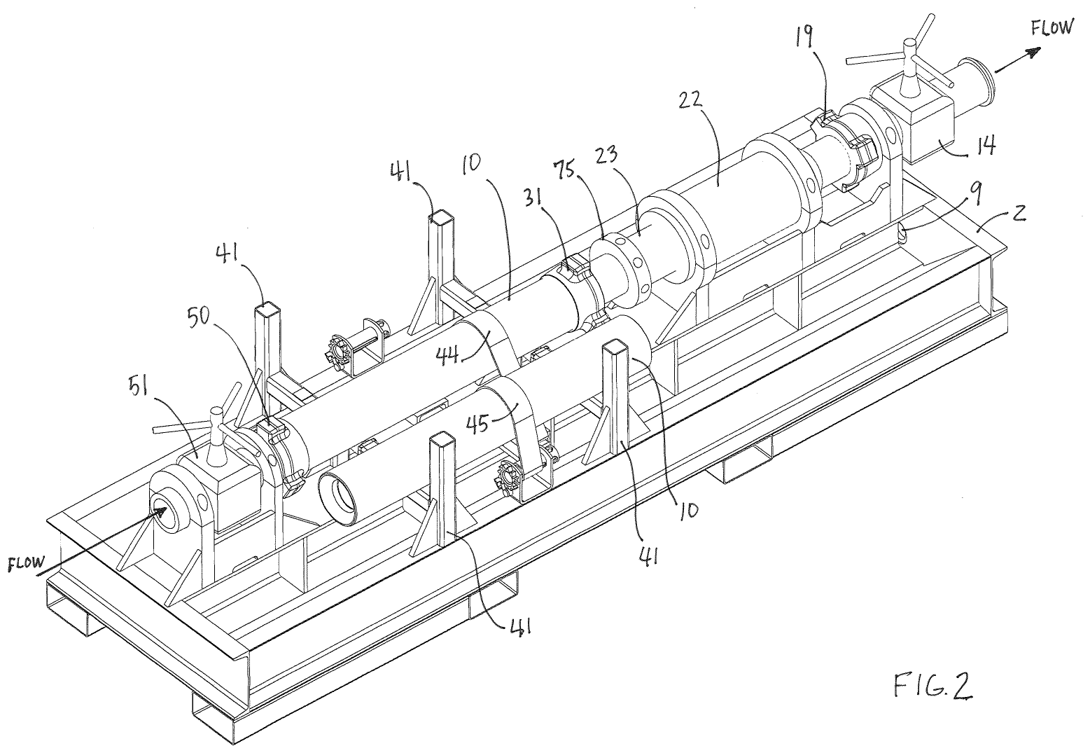

Turning now to the figures, a surface unit 1 for filtration of drilling and completion fluids (referred to generally below as fluids) is shown in FIGS. 1 and 2. With reference to those figures, all structural members and components are generally constructed from steel or stainless steel per customer requirements. Also, and as will be explained further below, any reference to “filtration” or “filters” means any component residing within the filter cartridge 10 that accomplishes the functions of a filter, a screen, a diffuser, or combinations of those devices, including any of those devices which may include magnetic elements for ferrous metal debris removal, or any other component that serves one or more of those functions.

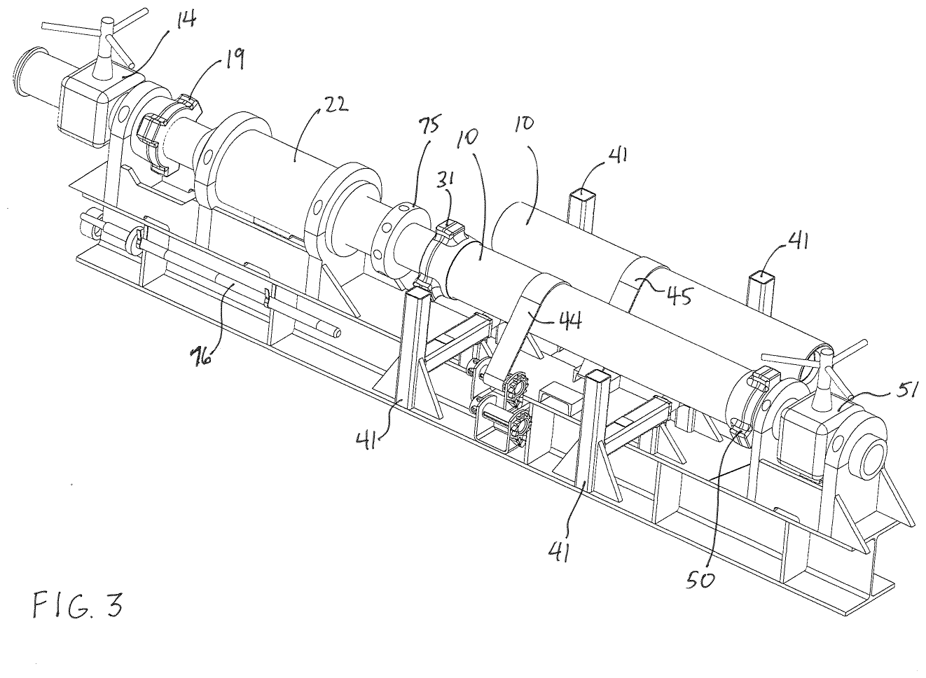

All parts of the surface unit 1 typically reside on a skid 2, such as a steel frame to facilitate handling with cranes, forklifts, or other carrying machinery. The skid 2 includes at least two lengthwise beams 3, 4 and at least two cross members 5, 6 to establish a rigid structure that can be lifted to position the surface unit 1 at a desired location at the rig site. The skid 2 further includes a plurality of open cross members 7 having openings to accommodate the lifting members of a forklift for moving the surface unit 1 as required. Optionally, but preferably, a trough 8 is formed along the length of the skid 2 for the collection of fluids which may exit the system during change-out of the filter cartridge 10, and the trough 8 includes a discharge port 9 for delivering such drained fluids to a container for disposal or treatment. If a skid 2 and/or trough 8 is not used, then the remaining components can reside on any other surface at the site (such as positioned on blocks), similar to the embodiment shown in FIG. 3.

In a preferred embodiment, a main beam 11 in the form of an I-beam is attached by welding between the cross members 5, 6 generally parallel to the longitudinal axis of the skid 2. The main beam 11 serves as a structural base for the necessary gate valves 14, 51, table frame 40, ram sleeve 20, and other structural components as will be described in detail below.

A first gate valve 14 is positioned on the downstream end of the surface unit 1 and is supported by a first gate valve support clamp 15 extending from the main beam 11. The support clamp 15 comprises a clamp base 16 and a clamp cap 17 attached to one another by bolts. The first gate valve 14 can be manually operated using the handwheel 18 to open or close the first gate valve 14 as needed. The upstream side of the first gate valve 14 includes an internally threaded first hammer union 19 that engages the ram sleeve 20. Directional arrows are shown in FIGS. 1 and 2 to denote the fluid flow direction during operation.

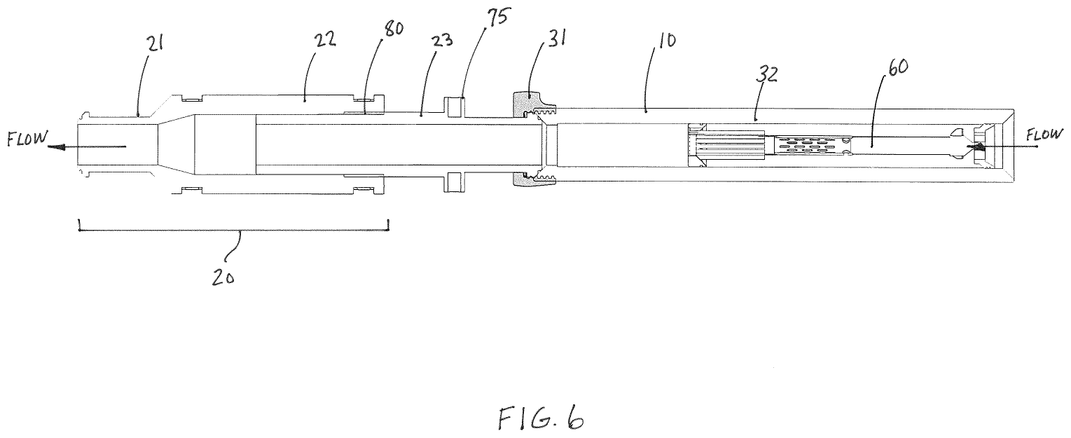

The downstream end of the ram sleeve 20 includes a first cylinder 21 having an end that is matably engaged by the first hammer union 19. The first hammer union 19 is rotatably secured on the first gate valve 14. The upstream end of the first cylinder 21 transitions to a larger diameter ram cylinder 22 that telescopingly receives an externally threaded second cylinder 23 (or “ram conduit”) that moves forward and backward within the internally threaded ram cylinder 22 as will be described. The threaded connection 80 between the ram cylinder 22 and the second cylinder 23 are best seen in FIG. 6. The ram sleeve 20 is supported by ram sleeve support clamps 24 extending from the main beam 11. The ram sleeve support clamps 24 function similarly to clamp 15.

A plurality of resilient members, such as O-rings, are located within the ram cylinder 22 and in contact with the second cylinder 23 during telescopingly slidable contact during change-out operations and to maintain a sealed connection between the ram cylinder 22 and the second cylinder 23 as fluids flow through the surface unit 1. Alternatively, O-rings may be located on the second cylinder 23 rather than the ram cylinder 22, as long as a sealed relationship is established. The upstream end of the second cylinder 23 further includes a second internally threaded hammer union 31 that matably engages a carrier sub 32 (a conduit that contains the filter, screen, or diffuser 60, referred to collectively herein as a filter cartridge 10) as will be described further below. A sectional view of the slidable relationship between the ram cylinder 22 and the second cylinder 23 is shown in FIG. 6.

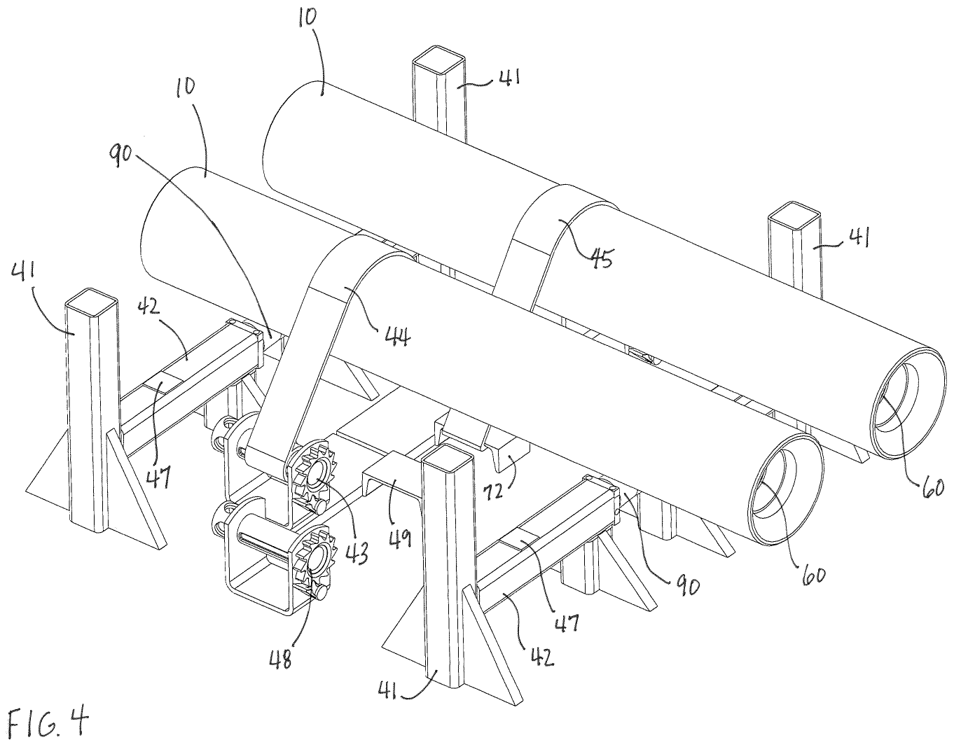

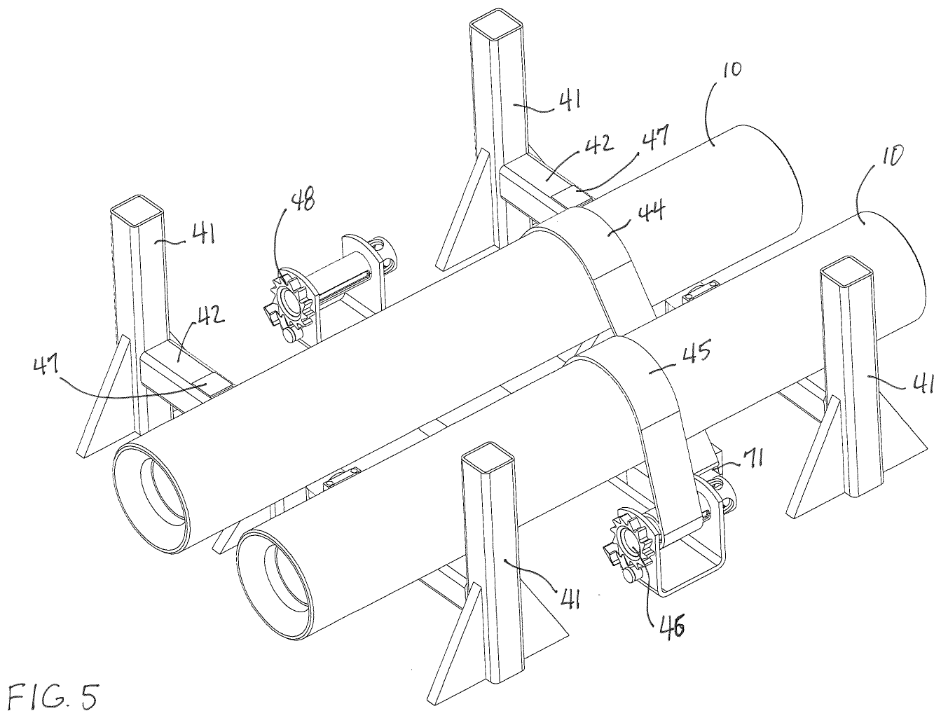

A table frame 40 for facilitating a change of filter cartridge 10, shown in more detail in FIGS. 4 and 5, is secured to the longitudinal members 3, 4 of the skid 2 and the main beam 11. The table frame 40, constructed preferably from steel tubing, includes four vertical support posts 41, with one pair of vertical support posts 41 extending from one side of the skid 2, and another pair of vertical support posts 41 extending from the opposite side of the skid 2. The table frame 40 further includes two additional horizontal table members 42 extending perpendicular to the longitudinal axis of the skid 2, effectively creating a work surface on which to roll the heavy filter cartridge 10 into and out of position when the filter cartridge 10 must be replaced. An optional first filter cartridge strap 44 having a hook end is wound around a lockable ratchet device 43 and securable over the filter cartridge 10 being used during filtration operations. The filter cartridge strap 44 can be secured around the filter cartridge 10 by connection of the hook end to a first fixed attachment member 71 located on the main beam 11. A second filter cartridge strap 45 having a hook end is wound around a second lockable ratchet 46 attached on the opposite side of the table frame 40 to retain a “clean” filter cartridge 10 that will replace the filter cartridge 10 in use. The filter cartridge strap 45 can be secured around the filter cartridge 10 by connection of the hook end to a second fixed attachment member 72 located on the main beam 11. Preferably, the horizontal table members 42 include one or more raised tabs or bosses 47 that help to align the filter cartridge 10 (whether clean or dirty) into a secure position against vertical support posts 41 and strapped down as needed. Once a “dirty” filter cartridge 10 is removed, it can be rolled into position on the table frame 40 and secured by a third filter cartridge strap between ratchet device 48 and attachment member 49.

As shown in FIG. 6, each filter cartridge 10 comprises a carrier sub 32 configured to contain a filter, screen, or diffuser (collectively, a “filter”) 60 as selected by the operator for the particular job requirements. Such filter 60 may also include magnetic elements for collecting ferrous metals entrained within the fluids. Both ends of the carrier sub 32 are externally threaded to matingly engage the second hammer union 31 on the second cylinder 23 and a third hammer union 50 on the second gate valve 51. The internal ends of the carrier sub 32 are tapered to mate with the tapered ends of the second cylinder 23 and the second gate valve 51, both of which include one or more resilient members or O-rings to establish a sealing relationship when the carrier sub 32 with its internal filter (collectively, the filter cartridge 10) is fully attached within the surface unit 1.

The second gate valve 51 is positioned on the upstream end of the surface unit 1 and is supported by a pair of second gate valve support clamps 52, 53 extending from the main beam 11. Each of the support clamps 52, 53 comprises a clamp base and a clamp cap attached to one another by bolts in the same manner as support clamp 15 for the first gate valve 14. The second gate valve 51 can be manually operated using the handwheel 54 to open or close the valve 51 as needed. As noted above, the downstream side of the second gate valve 51 includes an internally threaded third hammer union 50 that engages the upstream end of the carrier sub 32.

Operation of the present invention will now be described. When the surface unit 1 is fully assembled and the filter cartridge 10 is in place, i.e., sealed between the second and third hammer unions 31, 50 and in an operating configuration, fluid flows through the second gate valve 51 and through the filter cartridge 10 to remove, retain, or diffuse debris. Fluid continues to flow through the second cylinder 23, the ram cylinder 22, and then exiting through first gate valve 14. When the filter cartridge 10 needs to be replaced, the following steps are taken. First, the flow of fluids is stopped by turning the pump off and closing both the first and second gate valves 14, 51. Next, the second hammer union 31 is rotated to detach it from the downstream end of the carrier sub 32. Then, the second cylinder 23 is rotated via its threaded connection into the ram cylinder 22 to move it away from the filter cartridge 10. The second cylinder 23 includes a circumferential ring 75 having a plurality of holes for receiving a manually held rod 76 to assist in the rotation of the second cylinder 23. When not in use, the rod 76 can be conveniently placed in a rack 77 on the skid 2. If the optional strap 44 was used, ratchet 43 is loosened and strap 44 is disconnected from attachment member 71. The third hammer union 50 is then rotated to detach it from the upstream end of the carrier sub 32 so that the entire filter cartridge 10 is free. Any remaining fluids within the filter cartridge 10 are collected in the trough 8 and exit via the discharge port 9. The “dirty” filter cartridge 10 is then rolled away on the table frame 40 and secured temporarily by the “dirty” filter cartridge strap between ratchet device 48 and attachment member 49 until it can be removed for cleaning and refurbishing. The “clean” replacement filter cartridge 10 in the first “clean” filter cartridge strap 45 is then released from the strap 45 and rolled into position in line with the flow path, resting it on a pair of tapered rollers 90 on the horizontal table members 42, best shown in FIG. 4. The rollers 90 function to allow the filter cartridge 10 to move along the flow path as it is being secured. The third hammer union 50 is then reattached to the upstream end of the carrier sub 32. Next, the rod 76 is used with the circumferential ring 75 to threadably rotate the second cylinder 23 toward the carrier sub 32 until firm contact is made, and the second hammer union 31 is then reattached to the downstream end of the carrier sub 32. Now that the filter cartridge 10 is fully replaced and in sealing engagement with the surface unit 1, the optional strap 44 can be used to secure the filter cartridge 10, and first and second valves 14, 51 are then reopened and the pump turned on to reestablish fluid flow.

As will be appreciated, there are a number of advantages to the surface unit of the present invention over the prior art. First, the surface unit 1 enables quick change-out of filter cartridges 10 with filters, diffusers, and magnetic features that are suited to the specific fluid conditions at any time. This feature minimizes non-productive time (NPT) required to maintain the filtration process with as little down-time as possible. Second, the threadable and telescoping system enables manual operation of the surface unit 1 in a manner that is safer to the operators and which minimizes seizing of the filter cartridge 10 due to caked up debris removed from the fluids.

As will be understood, the embodiments of FIGS. 1-6 may be modified to suit a wide range of operational environments and combinations of features, and all such modifications are within the scope of the invention described and claimed herein.

All references cited in this specification are herein incorporated by reference as though each reference was specifically and individually indicated to be incorporated by reference. The citation of any reference is for its disclosure prior to the filing date and should not be construed as an admission that the present invention is not entitled to antedate such reference by virtue of prior invention.

It will be understood that each of the elements described above, or two or more together may also find a useful application in other types of methods differing from the type described above. Without further analysis, the foregoing will so fully reveal the gist of the present invention that others can, by applying current knowledge, readily adapt it for various applications without omitting features that, from the standpoint of prior art, fairly constitute essential characteristics of the generic or specific aspects of this invention set forth in the appended claims. The foregoing embodiments are presented by way of example only; the scope of the present invention is to be limited only by the following claims.

The invention claimed is:

1. A system for in-line filtering of fluids, comprising:
(a) a filter cartridge comprising a filter contained within a filter conduit;
(b) a first valve in fluid communication with a first end of the filter cartridge;
(c) a second valve in fluid communication with a second end of the filter cartridge; and
(d) a threadable ram conduit in fluid communication between the first valve and the filter cartridge, wherein the threadable ram conduit is movable between a first position to sealingly engage the filter cartridge and a second position to disengage the filter cartridge.

2. The system of claim 1, wherein the first position and the second position of the ram conduit are achieved by manual power.

3. The system of claim 1, wherein the filter is a diffuser.

4. The system of claim 1, wherein the filter is a screen.

5. The system of claim 1, wherein the filter includes magnets to collect ferrous metals.

6. The system of claim 1, wherein the first valve and the second valve are attached to a skid.

7. The system of claim 7, wherein the skid includes a trough having a discharge port.

8. The system of claim 1, further including a table frame positioned below the filter cartridge, wherein the table frame includes a first retaining member adapted to retain a replacement filter cartridge.

9. The system of claim 1, further including a table frame positioned below the filter cartridge, wherein the table frame includes a second retaining member adapted to retain a filter cartridge that has been disengaged from the ram conduit.

10. The system of claim 1, further including a table frame positioned below the filter cartridge, wherein the table frame includes one or more rollers adapted to align the filter cartridge with a flow path and to allow the filter cartridge to move along the flow path as it is secured.

11. The system of claim 1, wherein the ram conduit is sealingly and threadably disposed within a ram sleeve.

12. A method of in-line filtering of fluids, comprising the steps of:
(a) providing a filter cartridge having a filter contained within a filter conduit, wherein the filter cartridge has a first end and a second end, wherein the first end of the filter cartridge is in fluid communication with a first valve, and wherein the second end of the filter cartridge is in fluid communication with a second valve;
(b) providing a threadable ram conduit in fluid communication between the first valve and filter cartridge;
(c) positioning the ram conduit to sealingly engage the filter cartridge; and
(d) opening the first valve and the second valve to allow the fluid to flow through the filter cartridge.

13. The method of claim 12, further comprising the steps of:
(e) after a predetermined period, closing the first valve and the second valve;
(f) positioning the ram conduit to disengage the filter cartridge;
(g) positioning a replacement filter cartridge between the first valve and the second valve; and
(h) positioning the ram conduit to sealingly engage the replacement filter cartridge.

14. The method of claim 12, wherein positioning the ram conduit to sealingly engage the filter cartridge is achieved using manual power.

15. The method of claim 12, wherein the filter is a diffuser.

16. The method of claim 12, wherein the filter is a screen.

17. The method of claim 12, wherein the filter includes magnets to collect ferrous metals.
